(19) United States
(12) Patent Application Publication
(10) Pub. No.: US 2005/0193177 A1
(43) Pub. Date: Sep. 1, 2005

(54) Selectively transmitting cache misses within coherence protocol

(76) Inventors: Adrian C. Moga, Portland, OR (US); John M. Borkenhagen, Rochester, MN (US); Russell M. Clapp, Portland, OR (US)

Correspondence Address: LAW OFFICES OF MICHAEL DRYJA, 704 228TH AVE NE, #694, SAMMAMISH, WA, 98074, US

(21) Appl. No.: 10/790,169

(22) Filed: Mar. 1, 2004

(51) Int. Cl. G06F 12/00

(52) U.S. Cl. 711/145; 711/141

(57) ABSTRACT

Selectively transmitting cache misses within multiple-node shared-memory systems employing coherence protocols is disclosed. A cache-coherent system includes a number of nodes employing a coherence protocol to maintain cache coherency, as well as memory that is divided into a number of memory units. There is a cache within each node to temporarily store contents of the memory units. Each node further has logic to determine whether a cache miss relating to a memory unit should be transmitted to one or more of the other nodes lesser in number than the total number of nodes within the system. This determination is based on whether, to ultimately reach the owning node for the memory unit, such transmission is likely to reduce total communication traffic among the total number of nodes and unlikely to increase latency as compared to broadcasting the cache miss to all the nodes within the system.

### FIELD OF THE INVENTION

This invention relates generally to coherence protocols for use within cache-coherence systems, and more particularly to broadcast-oriented coherence protocols for use within such systems.

### BACKGROUND OF THE INVENTION

Multiple-node shared-memory systems include memory that is shared among the systems' nodes. In some types of these systems, each of the nodes has local memory that is part of the shared memory, and that is thus shared with the other nodes. The specific node at which a particular part of the shared memory physically resides is referred to as the home node for that part of the memory. This memory may be referred to as local memory for the home node, which is remote memory for the other nodes. The shared memory of a system may be divided into individual memory units, such as memory lines, memory addresses, and so on.

To improve performance of multiple-node shared-memory systems, nodes commonly include caches to temporarily store the contents of memory, either local memory, remote memory, or both local and remote memory. Frequently, directories are employed to track the status of local memory that has been cached by other nodes. For instance, a directory entry for each memory unit of local memory of a node may indicate whether the memory unit is uncached, shared, or modified. An uncached memory unit has not been cached by any of the other nodes. A shared memory unit has been cached by one or more of the other nodes, but none of these nodes has modified, or changed, the contents of the memory unit. A modified memory unit has been cached by one or more of the other nodes, and one of these nodes, or the home node of the memory unit to which the memory unit is local, has modified, or changed, the contents of the memory unit. Possibly, the directory entry for the memory unit further tracks the identities of which remote nodes have cached the unit, if any, as well as the identities of which remote node has modified the contents of the unit, if any.

Furthermore, a remote node that is caching a memory unit of remote memory has a cache entry for that memory unit within its cache that may mark the cached memory unit as shared, dirty, or invalid, as is now described. The contents of a cached memory unit that is marked as shared are valid, and have not changed relative to the contents of the memory unit as stored at the home node for the memory unit. The contents of a cached memory unit that is marked as dirty are also valid, but the remote node that has marked this memory unit as dirty has changed the contents of the memory unit as compared to the contents of the unit as stored at the home node for the memory unit. The contents of a memory unit cached by a given remote note are marked as invalid are not valid, in that a different remote node has changed the contents of the memory unit, such that the contents of the memory unit as cached by the given remote node no longer reflects the current, valid contents of this memory unit. For any given memory unit, the protocol defines one owning node. Under one possible convention, if the home node for the unit is storing the current contents of the unit, then the home node is referred to as the owning node for the memory unit. Otherwise, the remote node that is storing the current contents of the memory unit and which has the memory unit marked as dirty, is the owning node for the memory unit.

A cache coherence protocol is a protocol that controls the manner by which the nodes of a multiple-node shared-memory system communicate with one another so that the cached memory units are consistent, or coherent. That is, a cache coherence protocol controls the manner by which such nodes communicate with one another so that cached memory units are properly marked as shared, dirty, or invalid by the remote nodes caching the memory units, and are properly marked as uncached, shared, or modified by local nodes that are the home nodes of the memory units. There are generally two types of cache coherence protocols: unicast, or point-to-point or directory-based, protocols; and, broadcast, or snooping, protocols.

In general, when an originating node needs to access the contents of a given memory unit, be it a local or a remote memory unit, the node first checks its cache or directory to determine whether it has a valid copy of the contents of the memory unit. In the case of a local memory unit for which the originating node is the home node, this means verifying that no remote nodes have modified the contents of the memory unit. In the case of a remote memory unit, this means checking that the originating node has cached a copy of the contents of the memory unit that is shared or dirty, and not invalid. Where the contents of the memory unit have been modified by a remote node, in the case of a local memory unit, or where the copy of the contents of the memory unit is not cached, or cached as invalid, in the case of a remote memory unit, it is said that a cache miss has occurred. As a result, the originating node must obtain the contents of the memory unit from another node of the multiple-node, shared-memory system.

In a unicast, or point-to-point or directory-based, cache coherence protocol, the originating node always sends a single request—i.e., the cache miss—for the contents of the memory unit to one other node. Where the memory unit is local to the originating node, such that the originating node is the home node for the memory unit, the originating node sends a single request for the contents of the memory unit to the remote node that has modified the contents of the memory unit. In response, the remote node sends the contents of the memory unit, as have been modified, back to the originating node. Where the memory unit is remote to the originating node, the originating node sends a single request for the contents of the memory unit to the home node for the memory unit. Because the home node for the memory unit may not actually hold the current contents of the memory unit, it may have to forward the request to a third node, which may have modified the contents of the memory unit.

Unicast, or point-to-point or directory-based, cache coherence protocols minimize total communication traffic among the nodes of a multiple-node shared-memory system, because cache-coherence requests resulting from cache misses are only sent from an originating node to one or two other nodes, in the most frequent scenarios. Therefore, such systems generally have good scalability, because adding nodes does not add an inordinate amount of communication traffic among the nodes for cache coherence purposes. However, latency may suffer within systems using such cache coherence protocols, since the recipient node of the originating node's request may not actually have the current contents of the desired memory unit, requiring the recipient node to forward the request to another node.

By comparison, in a broadcast, or snooping, cache coherence protocol, the originating node always broadcasts a request for the contents of a memory unit to all the other nodes of the system. Only one of the nodes that receive the request from the originating node actually has the current contents of the memory unit and holds ownership, such that just this node responds to the originating node. Latency within such cache coherence protocols is very good, since it is guaranteed that a request for the contents of a memory unit from an originating node will never be forwarded, because all the other nodes receive the request in the initial transmission from the originating node. However, multiple-node shared memory systems using such cache coherence protocols generally do not have good scalability. Adding nodes adds an inordinate amount of communication traffic among the nodes for cache coherence purposes, requiring prohibitive increases in the communication bandwidth among the nodes.

### SUMMARY OF THE INVENTION

The invention relates to selectively transmitting cache misses within multiple-node shared-memory systems employing broadcast-oriented coherence protocols. A cache-coherent system of the invention includes a number of nodes employing a coherence protocol to maintain cache coherency, as well as memory that is divided into a number of memory units. There is a cache within each node to temporarily store contents of the memory units. Each node further has logic to determine whether a cache miss relating to a memory unit should be transmitted to one or more of the other nodes (and lesser in number than the total number of nodes within the system). This determination is based on one or more criteria. For instance the criteria may include whether, to ultimately reach the owning node for the memory unit, such transmission is likely to reduce total communication traffic among the total number of nodes and unlikely to increase latency as compared to broadcasting the cache miss to all of the nodes within the system.

One method of the invention determines at an originating node whether a cache miss relating to a memory unit of a shared memory system of a number of nodes including the originating node and that employs a coherence protocol should be selectively broadcast to one or more nodes lesser in number than the total number of nodes. This determination is based on one or more criteria. For instance, the criteria may include whether selective broadcasting is likely to reduce total communication traffic among the total number of nodes and unlikely to increase latency as compared to just broadcasting the cache miss to all of the nodes within the system, to reach the owning node for the memory unit. In response to determining that the cache miss should be selectively broadcast, the originating node selectively broadcasts the cache miss to the one or more nodes.

Another method of the invention determines at an originating node whether a cache miss relating to a memory unit of a shared memory system of a number of nodes including the originating node should be selectively broadcast to one or more other nodes. This determination is based on whether the originating node is a home node for the memory unit, or whether the originating node has a pre-stored hint as to a potential owning node for the memory unit. In response to determining that the cache miss should be selectively broadcast, the originating node selectively broadcasts the cache miss to the one or more other nodes. Otherwise, the originating node determines whether the memory unit relates to a predetermined memory sharing pattern encompassing some, but not all, of the nodes. In response to determining that the memory unit relates to the pattern, the originating node selectively broadcasts the cache miss to the nodes encompassed by the pattern.

A node of the invention is part of a cache-coherent system that includes a number of nodes including the node. The node includes local memory, a directory, a cache, and logic. The local memory is the memory for which the node is a home node, but that is shared among the other nodes of the system. The directory is to track which memory units of the local memory in the node have been cached or modified elsewhere (and where). The cache is to temporarily store contents of the local memory and of the memory of the other nodes, where the local memory and the memory of the other nodes are organized into memory units. The logic is to determine whether a cache miss relating to a memory unit should be transmitted to one or more nodes lesser in number than all of the nodes of the system. This determination is based on one or more criteria. The criteria may include whether, to ultimately reach the owning node for the memory unit, such transmission is likely to reduce total communication traffic among all the nodes and unlikely to increase latency as compared to broadcasting the cache miss to all the nodes.

One article of manufacture of the invention includes a computer-readable medium and means in the medium. The means is for selectively broadcasting a cache miss relating to a memory unit of a shared memory system having a number of nodes and that employs a coherence protocol. The cache miss is selectively broadcast to the owning node for the memory unit, where the originating node of the cache miss is the home node for the memory unit.

Another article of manufacture of the invention also includes a computer-readable medium and means in the medium. The means is for selectively broadcasting a cache miss relating to a memory unit of a shared memory system having a number of nodes and that employs a coherence protocol. The cache miss is selectively broadcast to the home node for the memory unit as well as to a potential owning node for the memory unit, where the originating node of the cache miss has at a cache thereof a pre-stored hint as to the potential owning node, as the node that sent an earlier received invalidation of the memory unit.

A third article of manufacture of the invention includes a computer-readable medium and means in the medium as well. The means is for selectively broadcasting a cache miss relating to a memory unit of a shared memory system having a number of nodes and that employs a coherence protocol. The cache miss is selectively broadcast to a smaller number of nodes as compared to all the nodes of the system, where the memory unit relates to a predetermined memory sharing pattern encompassing this smaller number of nodes.

Embodiments of the invention provide for advantages over the prior art. Whenever possible, logic is used to determine when broadcasting a cache miss to all the nodes of a system is not necessary to ideally reach the owning node of a memory unit without reissuing the cache miss, such that selective broadcasting suffices to ideally reach the owning node of the memory unit without reissuing the cache miss. Thus, embodiments of the invention are advantageous over unicast-only protocols that always unicast cache misses, because unicast-only protocols will necessarily incur forwarding latency in at least some instances, which is at least substantially avoided by embodiments of the invention.

Furthermore, because caches misses are not always broadcast to all the nodes within a system, embodiments of the invention are advantageous over broadcast-only cache coherence protocols that do not scale well due to their always broadcasting cache misses to all the nodes within a system. That is, embodiments of the invention only broadcast cache misses to all the nodes within a system where selective broadcasting is not likely to reduce communication traffic as compared to broadcasting or is unlikely to increase latency as compared to broadcasting. Thus, embodiments of the invention scale better than broadcast-only cache coherence protocols.

Still other advantages, aspect, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a cache-coherent, multiple-node, and shared-memory system, according to an embodiment of the invention.

FIG. 2 is a flowchart of a method for determining whether to selectively broadcast or broadcast a cache miss, according to an embodiment of the invention.

FIG. 3 is a diagram of a scenario in which selectively broadcasting a cache miss to a single node is more desirable than broadcasting the cache miss to all nodes, according to an embodiment of the invention.

FIG. 4 is a flowchart of a method for determining whether selectively broadcasting a cache miss to a single node is more desirable than broadcasting the cache miss to all nodes, and which is consistent with the method of FIG. 2, according to an embodiment of the invention.

FIG. 5 is a diagram of a scenario in which selectively broadcasting a cache miss to two nodes is more desirable than broadcasting the cache miss to all nodes, according to an embodiment of the invention.

FIG. 6 is a flowchart of a method for determining whether selectively broadcasting a cache miss to two nodes is more desirable than broadcasting the cache miss to all nodes, and which is consistent with the method of FIG. 2, according to an embodiment of the invention.

FIG. 7 is a diagram of a scenario in which selectively broadcasting a cache miss to a group of nodes lesser in number than all the nodes within a shared-memory system is more desirable than broadcasting the cache miss to all the nodes within the system, according to an embodiment of the invention.

FIG. 8 is a flowchart of a method for determining whether selectively broadcasting a cache miss to a group of nodes lesser in number than all the nodes within a shared-memory system is more desirable than broadcasting the cache miss to all the nodes within the system, and which is consistent with the method of FIG. 2, according to an embodiment of the invention.

FIG. 9 is a flowchart of a method for determining whether to selectively broadcast or broadcast a cache miss, which is consistent with the method of FIG. 2 and inclusive of the methods of FIGS. 4, 6, and 8, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Shared Memory System of Multiple Nodes, and Overview

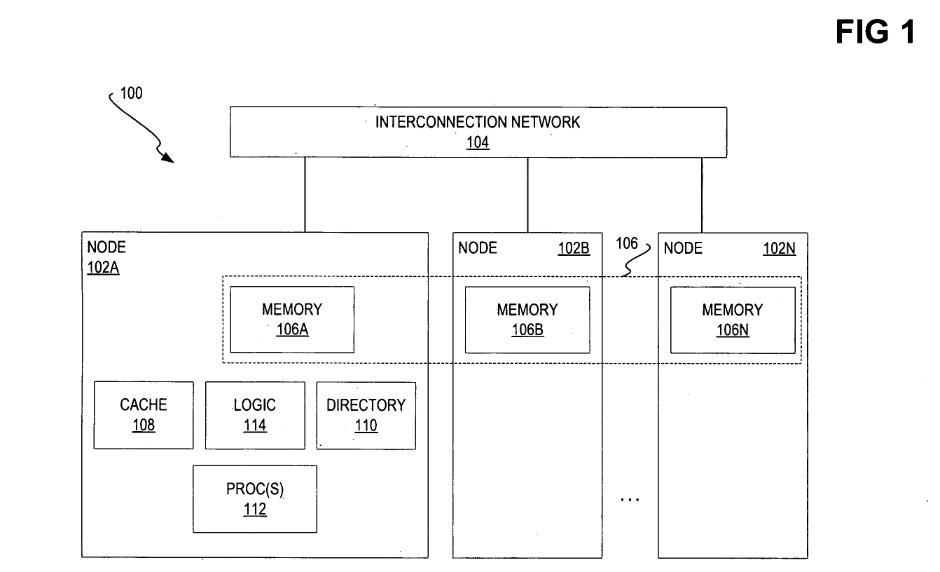

FIG. 1 shows a cache-coherent shared-memory system 100, according to an embodiment of the invention. The system 100 includes a number of nodes 102A, 102B, . . . , 102N, collectively referred to as the nodes 102. There are at least two of the nodes 102. For illustrative clarity, only the node 102A is depicted in detail in FIG. 1, although the other of the nodes 102 have components comparable to those of the node 102A. Each of the nodes 102 may be a computing device. The nodes 102 are interconnected with each other so that they may communicate with one another via an interconnection network 104.

The nodes 102A, 102B, . . . , 102N have memories 106A, 106B, . . . , 106N, collectively referred to as the shared memory 106 of the system 100. The memory 106A is local to the node 102A and remote to the other of the nodes 102; the memory 106B is local to the node 102B and remote to the other of the nodes 102; and, the memory 106N is local to the node 102N and remote to the other of the nodes 102. Thus, the system 100 can in one embodiment be a non-uniform memory access (NUMA) system, where a given node is able to access its local memory more quickly than remote memory. The memory 106 may be divided into a number of memory units, such as memory lines, memory addresses, and so on. Each of the nodes 102 is said to be the home node for some of the memory units, corresponding to those memory units that are part of the local memory of the node.

The node 102A is depicted as exemplarily includes, besides the memory 106A, a cache 108, a directory 110, one or more processors 112, and logic 114. As can be appreciated by those of ordinary skill within the art, the node 102A may include other components, in addition to and/or in lieu of those depicted in FIG. 1. The cache 108 is for temporarily storing the contents of memory units of the memory 106. The contents of a given memory unit cached within the cache 108 may be shared, dirty, or invalid. A cached memory is marked shared when the contents of the memory unit are valid, in that they can be relied upon as being the correct contents of the memory unit, and have not changed since the contents of the memory unit were received by the node 102A from the home node for the memory unit. A cached memory unit is marked dirty means when the contents of the memory unit are also valid, in that they can be relied upon as being the correct contents of the memory unit. However, the node 102A, which has cached this memory unit, has changed the contents of the memory unit itself since receiving the contents of the memory unit from the home node for the memory unit. The contents of an invalid memory are marked invalid when another of the nodes 102 has changed the contents of the memory unit as compared to the contents of the memory unit as stored in the cache 108.

The directory 110 is for tracking which one of the other nodes 102 have cached or modified the memory units of the local memory 106A of the node 102A. The contents of a given memory unit tracked within the directory 110 may be uncached, shared, or modified. An uncached memory unit has not been cached by any of the nodes 102, including the node 102A. The node 102A is referred to as the owning node for a memory unit that is uncached. A shared memory unit has been cached by one or more of the nodes 102, but none of these nodes has modified, or changed, the contents of the memory unit. One of the sharing nodes or node 102A is referred to as the owning node for a memory unit that is shared. A modified memory unit has been cached by one or more of the nodes 102, and one of these nodes has modified, or changed, the contents of the memory unit. The one of the nodes 102 that has most recently modified the contents of a memory unit is referred to as the owning node for such a memory unit. The processors 112 of the node 102A may run computer programs and processes that read the contents of memory units of the memory 106, and write the contents of these memory units.

To maintain consistency, or coherency, of the caches of the nodes 102, a cache coherence protocol is employed by the nodes 102 of the shared-memory system 100. The protocol determines how cache misses are handled within the system 100. A cache miss may be defined by example with respect to the node 102A. When one of the processors 112 issues a request to read or write the contents of a memory unit of the memory 106 that is not currently cached within the cache 108, or that is marked as invalid within the cache 108, a cache miss is said to have occurred. A cache miss thus results when a request for the contents of a memory unit is not properly present within the cache 108, such that the request has “missed” the cache. The node 102A therefore has to forward the request—i.e., forward the cache miss—to one or more of the nodes 102 to obtain the current contents of the desired memory unit.

The logic 114 determines how the node 102A is to forward the cache miss to the nodes 102 in accordance with the coherence protocol. In particular, the logic 114 determines whether the cache miss should be selectively broadcast to a group of the nodes 102 lesser in number than the total number of the nodes 102, or broadcast to all the nodes 102.

In one embodiment, the logic 114 makes its determination based on whether, to ultimately reach the owning node for the memory unit that is the subject of the cache miss in question, selectively broadcasting the cache miss is likely to result in reduced total communication traffic among the nodes 102 and is unlikely to increase latency, as compared to broadcasting the cache miss to all of the nodes 102. A likely reduction of total communication traffic among the nodes 102 refers to whether the bandwidth of the interconnection network 104 used in ultimately reaching the owning node of the memory unit is likely to be less than the bandwidth used if the cache miss were broadcast to all of the nodes 102.

An unlikely increase in latency refers to the number of “hops” among the nodes 102 unlikely to increase than if the cache miss were broadcast to all of the nodes 102. For example, the logic 114 may compare whether to broadcast the cache miss from the node 102A to all the nodes 102, where there may be sixteen of the nodes 102, or to selectively broadcast the cache miss to just the node 102B. If the node 102N is the actual owning node for the memory unit that is the subject of the cache miss, then the cache miss may then be reissued as a full broadcast in the case where the cache miss is selectively broadcast from the node 102A just to the node 102B. Therefore, selective broadcasting is likely to increase latency in this example, because broadcasting the cache miss to all the nodes 102 means that the node 102N receives the cache miss from the node 102A directly, in one “hop” from the node 102A to the node 102N. By comparison, selectively broadcasting the cache miss from the node 102A to the node 102B incurs at least two more “hops” for cache miss to reach the owning node 102N: one “hop” from the node 102A to the node 102B, and another “hop” from the node 102B, denying ownership, to the node 102A.

In the above example, the total bandwidth is just slightly increased by two packets (to and from the node 102B) versus a full broadcast. However, in the case where the selection is successful, selective broadcast uses significantly fewer packets to reach the owner and collect the response(s).

The specific manner by which the logic 114 determines whether to selectively broadcast or broadcast a given cache miss is specifically described in subsequent sections of the detailed description. Furthermore, the specific lesser number of the nodes 102 to which a given cache miss should be selectively broadcast is particularly described in subsequent sections of the detailed description. The logic 114 may be implemented as hardware, software, or a combination of hardware and software.

It is noted that broadcasting a cache miss generally refers to sending a copy of the cache miss over the interconnection network 104 to all the nodes 102, such that each of the nodes 102 receives its own copy of the cache miss. By comparison, selectively broadcasting a cache miss to a group of the nodes 102 lesser in number than all of the nodes 102 generally refers to sending a copy of the cache miss over the network 104 to this group of the nodes 102, such that only each node in the group receives its own copy of the cache miss. Selective broadcasting the cache miss is inclusive of sending a copy of the cache miss to just one of the nodes 102 as well.

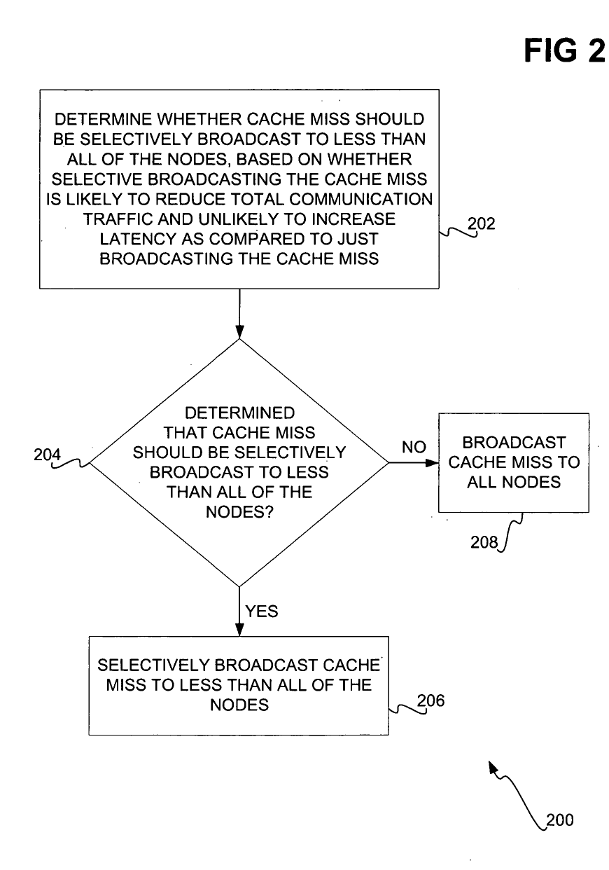

FIG. 2 shows a method 200 for sending a cache miss by a node, according to an embodiment of the present invention. The method 200 is provided as an overview of the logic 114 in one embodiment of the invention. The method 200, like other methods of embodiments of the invention, may be implemented as means in a computer-readable medium of an article of manufacture. The computer-readable medium may be a recordable data storage medium, a modulated communications signal, or another type of medium. The method 200 is performed by the logic of an originating node of a cache miss. The originating node of a cache miss is the node at which the cache miss occurred, and thus is the node that is to send (e.g., selectively broadcast or broadcast) the cache miss to other nodes.

The originating node determines whether the cache miss in question should be selectively broadcast to less than all of the nodes of the shared-memory system of which the originating node is a part (202). This determination is based on one or more criteria. In one embodiment, the criteria includes whether selective broadcasting the cache miss is likely to reduce total communication traffic among all the nodes of the system, and unlikely to increase latency, in reaching the owning node of the memory unit that is the subject of the cache miss, as compared to broadcasting the cache miss to all of the nodes. If the originating node determines that such selective broadcasting is more desirable in this regard (204), then the cache miss is selectively broadcast to less than all of the nodes (206). Otherwise, the cache miss is broadcast to all of the nodes (208).

The following three sections of the detailed description describe specific embodiments of the present invention in which cache misses are selectively broadcast to one or more other nodes from an originating node. Each of these specific embodiments can be employed separately, or in combination with either or both of the other specific embodiments. Furthermore, in the conclusion section of the detailed description, a discussion will be provided that combines all three of these specific embodiments of the present invention. As can be appreciated by those of ordinary skill within the art, however, the method 200 encompasses embodiments other than those particularly described in the next three sections of the detailed description, and in the conclusion section of the detailed description.

First Embodiment for Selectively Broadcasting Cache Misses

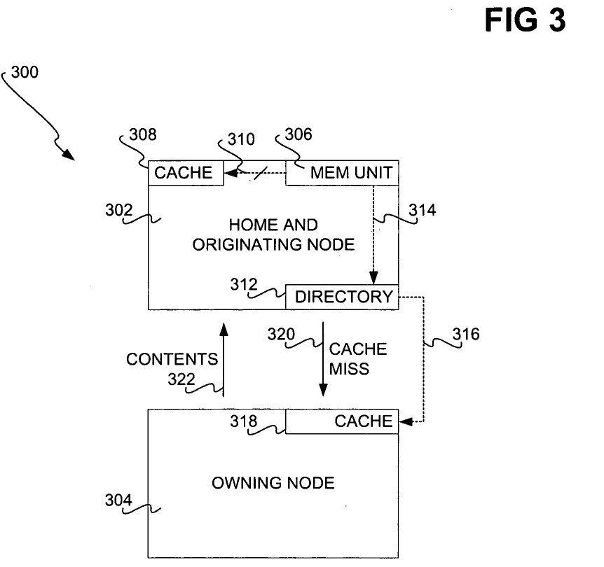

FIG. 3 illustratively depicts a scenario 300 in which selectively broadcasting a cache miss to one node is more desirable than broadcasting the cache miss to all the nodes, according to an embodiment of the invention. The scenario 300 includes nodes 302 and 304. The node 302 is the home node for a memory unit 306 that is the subject of a request within the node 302. The memory unit 306, however, is not cached within the cache 308 of the node 302, as indicated by the crossed arrow 310, resulting in a cache miss. Furthermore, because the node 302 is the home node for the memory unit 306, the current owning node is identified within the directory 312, as indicated by the arrow 314. As indicated by the arrow 316 in FIG. 3, the directory 312 identifies the node 304 as the owning node 304, which maintains the proper current contents of the memory unit 306 in its cache 318.

Therefore, the node 302, as the originating node of the cache miss, selectively broadcasts the cache miss to the node 304, as indicated by the arrow 320. In response, the node 304, as the owning node of the memory unit in question, sends the current contents of the memory unit, as stored in its cache 318, to the node 302, as indicated by the arrow 322. Selectively broadcasting the cache miss from the node 302 to the node 304 results in the cache miss reaching the owning node of the memory unit—the node 304—in one “hop,” such that latency is not increased as compared to if broadcasting the cache miss to all the nodes were instead accomplished. Furthermore, selectively broadcasting the cache miss from the node 302 to the node 304 results in less communication traffic among all the nodes than if broadcasting the cache miss to all the nodes were accomplished, where there is at least one additional node besides the nodes 302 and 304.

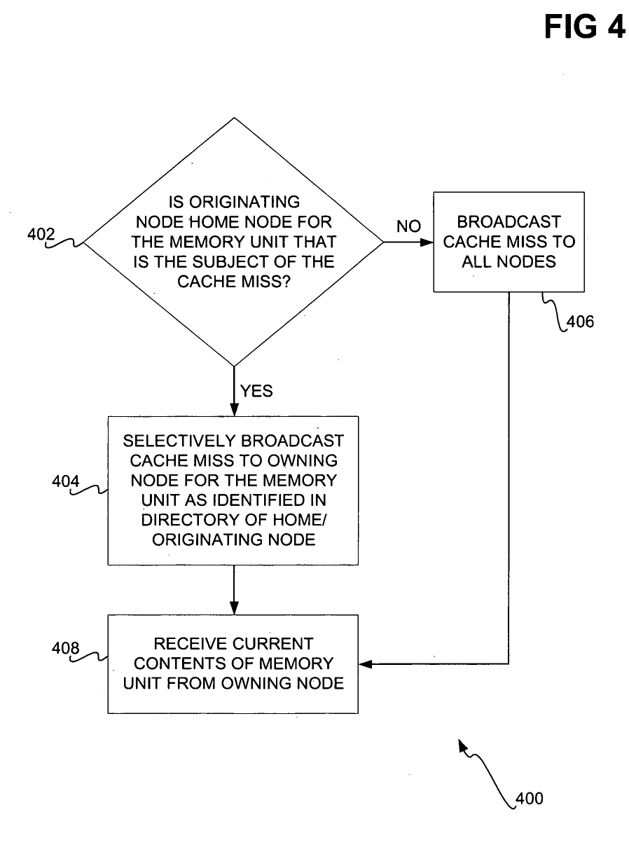

FIG. 4 shows a method 400 for determining whether selectively broadcasting a cache miss to one node is more desirable than broadcasting the cache miss to all the nodes, consistent with the scenario 300 of FIG. 3, according to an embodiment of the invention. The method 400 is consistent with the method 200 of FIG. 2 that has been described, and is performed by the originating node of a cache miss that relates to a given memory unit of shared memory. The originating node determines if it is the home node for the memory unit that is the subject of the cache miss (402). If so, then the originating node simply selectively broadcasts the cache miss to the current owning node for the memory unit (404), as identified in directory of the originating/home node. Otherwise, the originating node broadcasts the cache miss to all the nodes (406), in the embodiment of FIG. 4. In either case, the originating node ultimately receives the current contents of the memory unit from the owning node (408).

### Second Embodiment for Selectively Broadcasting Cache Misses

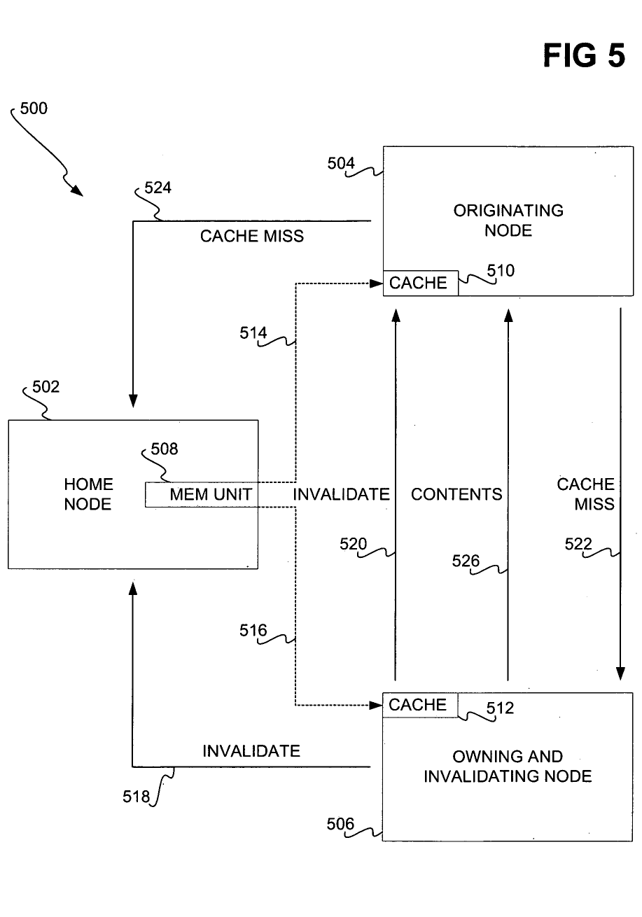

FIG. 5 illustratively depicts a scenario 500 in which selectively broadcasting a cache miss to two nodes is likely more desirable than broadcasting the cache miss to all the nodes, according to an embodiment of the invention. The scenario 500 includes at least the nodes 502, 504, and 506. The node 502 is the home node for a memory unit 508. The memory unit 508 is initially share-cached by both the node 504 in its cache 510 and the node 506 in its cache 512, as indicated by the arrows 514 and 516. Thereafter, the node 506 has modified the contents of the memory unit 508, such that the node 506 is an invalidating node, and sends an invalidate notice regarding the memory unit 508 to all of the other nodes, including the home node 502 and the node 504, as indicated by the arrows 518 and 520, respectively. Because the invalidate notice includes the identity of the invalidating node 506, the node 504 is able to store this identity within the cache 510, where previously the contents of the memory unit 508 were stored.

The memory unit 508 then becomes the subject of a request within the node 504. However, the node 504 determines that its cached copy of the memory unit 508 in the cache 510 is invalid. Therefore a cache miss results, and the node 504 becomes the originating node of this cache miss. The node 504 has a pre-stored hint as to the current owning node of the memory unit 508, in the form of the identity of the node 506 stored within the cache 510 where previously the contents of the memory unit 508 were stored. The originating node 504 therefore selectively broadcasts the cache miss to both the home node 502 and the node 506, as indicated by the arrows 522 and 524, respectively, instead of broadcasting the cache miss to all the nodes, including nodes not depicted in FIG. 5. Where the node 506 is still the current owning node for the memory unit 508, it responds with the current contents of the memory unit 508, as indicated by the arrow 526. It is noted that the pre-stored hint is not limited to just one entry (e.g., the identity of the invalidating node 506), and that the hint(s) can be updated during any subsequent invalidations of the same memory unit.

In the scenario 500 specifically depicted in FIG. 5, selectively broadcasting the cache miss from the originating node 504 both to the home node 502 and the owning and invalidating node 506 does not result in increased latency in the cache miss reaching the owning node 506 as compared to broadcasting the cache miss to all the nodes, including nodes other than the nodes 502, 504, and 506. This is because the cache miss reaches the owning node 506 in one “hop,” just as it would if the cache miss were broadcast instead. Furthermore, selectively broadcasting the cache miss from the originating node 504 both to the home node 502 and the owning and invalidating node 506 does not result in increased bandwidth usage as compared to broadcasting the cache miss, where there are more nodes besides the nodes 502, 504, and 506 depicted in FIG. 5.

The originating node 504 selectively broadcasts the cache miss to the home node 502 in addition to the node 506 to update the home node directory. This also helps in case the hint as to the identity of the owning node as the node 506 is no longer valid, and is stale. For example, after the node 506 has invalidated the memory unit 508 by modifying it, the node 506 may subsequently erase the memory unit 508 from its cache and update the memory in the home node 502. In such instances, the pre-stored hint as to the owning node of the memory unit 508 stored in the cache 510 of the node 504, as the node 506, is no longer valid and is stale. Thus, having the originating node 504 selectively broadcast the cache miss to the home node 502 in addition to the node 506 may reduce latency in the case where the identity of the owning node of the memory unit 508 as stored in the cache 510 is no longer current.

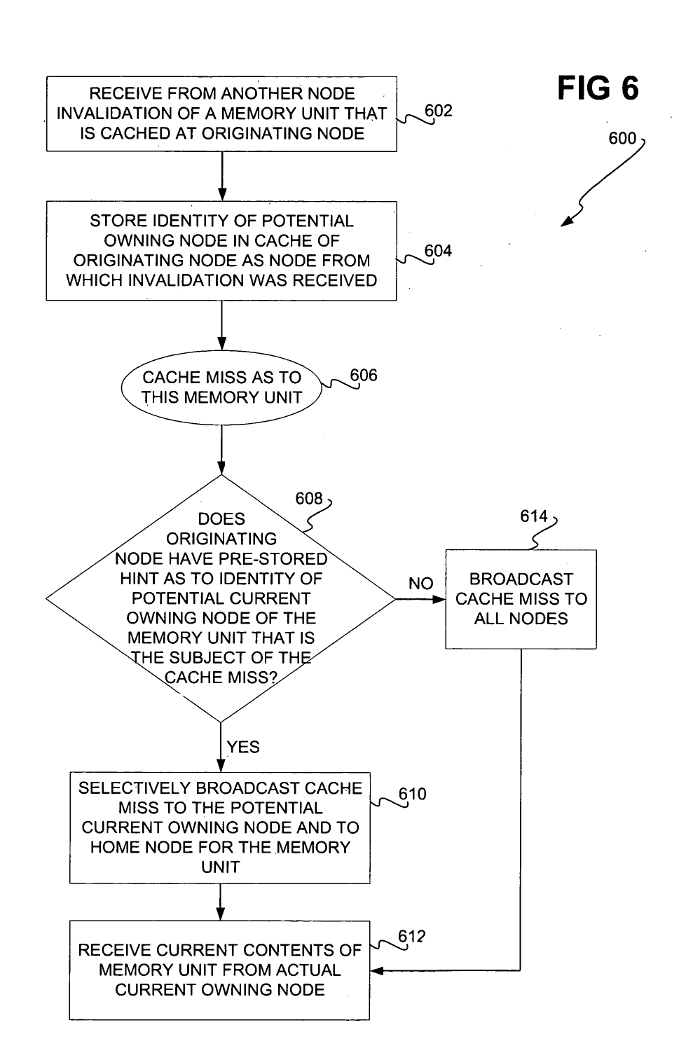

FIG. 6 shows a method 600 for determining whether selectively broadcasting a cache miss to two nodes is more desirable than broadcasting the cache miss to all the nodes, consistent with the scenario 500 of FIG. 5, according to an embodiment of the invention. The method 600 is consistent with the method 200 of FIG. 2 that has been described, and is performed by the originating node of a cache miss that relates to a given memory unit of shared memory. The originating node first receives an invalidation notice from another node regarding a memory unit that the originating node has cached (602). In response, the originating node stores the identity of a potential owning node for the memory unit within its cache, as the node from which the invalidation notice was received (604).

Thereafter, a cache miss as to this memory unit is generated by the originating node (606). Where the originating node still has the pre-stored hint as to the identity of the potential current owning node of the memory unit (608), then the originating node selectively broadcasts the cache miss to the potential current owning node, as well as to the home node for the memory unit (610). Ultimately, the originating node receives the current contents of the memory unit from the actual current owning node (612). Where the potential current owning node of the memory unit is the actual current owning node, then only one “hop” transpires in the cache miss reaching the actual current owning node, the selective broadcasting of the cache miss from the originating node to this node. Where the potential current owning node of the memory unit is not the actual current owning node, then two extra “hops” transpire in the cache miss reaching the actual current owning node: the selective broadcasting of the cache miss from the originating node to the home node for the memory unit and the hinted node(s); and, the negative responses returning to the originating node.

Where the originating node no longer has the pre-stored hint as to the identity of the potential current owning node of the memory unit (608), then in the embodiment of FIG. 6 the originating node broadcasts the cache miss to all the nodes (614), and receives the current contents of the memory unit from the actual current owning node (612). In this situation, bandwidth is increased as compared to the selective broadcasting situation described in the previous paragraph. Latency is at least as good when broadcasting as compared to the selective broadcasting situation described in the previous paragraph, because only one “hop” is needed for the cache miss to reach the actual current owning node from the originating node.

Therefore, in the embodiment of the invention described in relation to FIGS. 5 and 6, it is likely that latency will not increase when selective broadcasting a cache miss from an originating node both to the home node for the memory unit in question and to the potential owning node identified in the cache of the originating node. However, latency does not actually increase only when the potential owning node is the actual current owning node. Where the potential owning node is no longer the actual current owning node, then latency increases by two “hops,” since the originating node has to reissue the cache miss as a full broadcast. Furthermore, it is noted that where the cache miss is selectively broadcast in 610 of the method 600 of FIG. 6, but where none of the recipient nodes that receive the selective broadcast is the current owning node of the memory unit, then a complete broadcast to all the nodes occurs so that it is guaranteed that the current owning node does in fact receive the cache miss. Thus, where the recipient nodes of the selective broadcast all respond negatively to this selective broadcast, then a complete broadcast is performed.

### Embodiment for Selectively Broadcasting Cache Misses

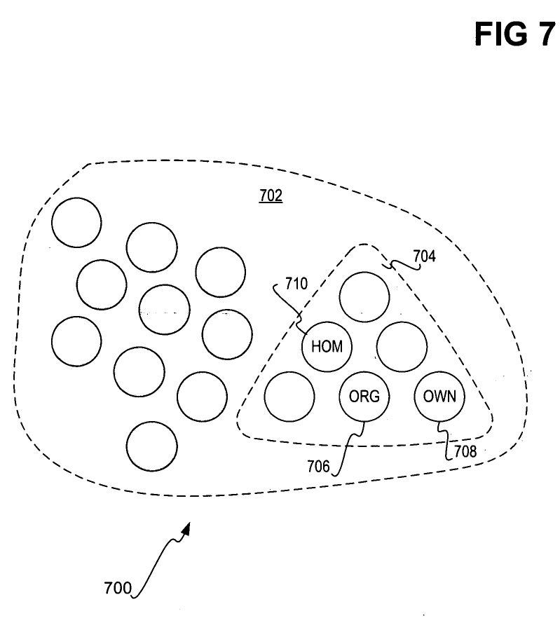

FIG. 7 illustratively depicts a scenario 700 in which selectively broadcasting a cache miss to a group of nodes lesser in number than all the nodes within a shared-memory system is more desirable than broadcasting the cache miss to all the nodes within the system, according to an embodiment of the invention. The scenario 700 includes a total of sixteen nodes 702. The sixteen nodes 702 include an unshaded group of nodes 704; whereas other of the nodes 702 that are not part of the group of nodes 704 are shaded to distinguish them from those of the nodes 702 that are part of the group of nodes 704. The group of nodes 704 is encompassed by a predetermined memory sharing pattern, where certain memory units are more likely to be accessed by the group of nodes 704, as opposed to other of the nodes 702. For instance, these memory units may have as their home nodes the group of nodes 704. The group of nodes 704 may be identified by any type of predetermined memory sharing pattern. For example, they may be within the same sub-network of nodes, they may all be intermediate neighbors within an interconnection network, they may all be at least partially executing the same application program, and so on.

As can be appreciated by those of ordinary skill within the art, however, embodiments of the present invention are not limited to any particular definition of the group of nodes 704. Furthermore, how the group of nodes 704 is defined is likely to depend specifically on the environment within which an embodiment of the invention is implemented—that is, on how data is likely to migrate within all the nodes 702, such that the group of nodes 704 can be defined among all the nodes 702. The examples presented here are meant to convey to those of ordinary skill within the art some suggestions as to how the group of nodes 704 can be defined, but the examples are not exhaustive, and many other groups can be defined, depending on the environment within which an embodiment of the present invention is implemented.

The node 706, which is part of the group of nodes 704, is identified as the originating node of a cache miss relating to a given memory unit. Furthermore, the home node for this memory unit, the node 710, is preferably within the group of nodes 704. For the sake of exemplary clarity, the owning node 708 is also within the group of nodes 704. The originating node 706, rather than broadcasting the cache miss to all of the nodes 702, instead selectively broadcasts the cache miss to just the group of nodes 704. Because the owning node 708 is within the group of nodes 704, the latency incurred in selectively broadcasting the cache miss to just the group of nodes 704 is the same as if the cache miss were broadcast to all the nodes 702. Furthermore, the bandwidth used in selectively broadcasting the cache miss to just the group of nodes 704 is less than if the cache miss were broadcast to all the nodes 702, because there are less nodes in the group of nodes 704 that receive the broadcasted cache miss as compared to all the nodes 702.

If the owning node 708 were not within the group of nodes 704, then the latency incurred in reaching the owning node 708 by selectively broadcasting the cache miss to the group of nodes 704 would require two extra “hops”: a first “hop” in broadcasting the cache miss from the originating node 706 to the group 704; and, a second “hop” in returning a negative response from group 704 to originating node 706. Selectively broadcasting the cache miss to the group of nodes 704 is desirable where such a group can be identified by a sharing pattern, because such selective broadcasting is still nevertheless likely to reduce bandwidth while unlikely to increase latency in reaching the owning node 708, as compared to broadcasting the cache miss to all the nodes 702.

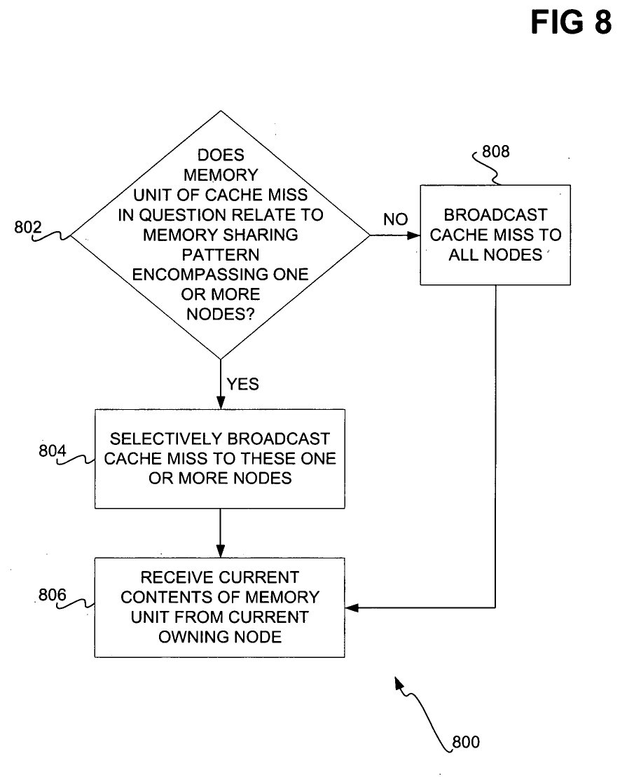

FIG. 8 shows a method 800 for determining whether selectively broadcasting a cache miss to a group of nodes lesser in number than all the nodes of a shared-memory system is more desirable than broadcasting the cache miss to all the nodes of the system, according to an embodiment of the invention. The method 800 is consistent with the scenario 700 of FIG. 7, and is also consistent with the method 200 of FIG. 2 that has been described. The method 800 is performed by the originating node of a cache miss that relates to a given memory unit of shared memory. The originating node determines whether the memory unit that is the subject of the cache miss in question relates to a memory sharing pattern encompassing one or more nodes (802), such as a group of nodes.

If so, then the originating node selectively broadcasts the cache miss just to these nodes (804), and receives the current contents of the memory unit back from the current owning node in response (806). The current owning node may be one of the nodes to which the cache miss was selectively broadcast. If not, the originating node will resort to a full broadcast upon collecting negative responses from its selective broadcast. If the originating node determines that the memory unit does not relate to a memory sharing pattern (802), however, then it broadcasts the cache miss to all the nodes of the system (808), and receives the current contents of the memory unit back directly from the current owning node (806). Furthermore, it is noted that where the cache miss is selectively broadcast in 804, but where none the recipient nodes that receive the selective broadcast is the current owning node of the memory unit, then a complete broadcast to all the nodes occurs so that it is guaranteed that the current owning node does in fact receive the cache miss. Thus, where the recipient nodes of the selective broadcast all respond negatively to this selective broadcast, then a complete broadcast is performed.

### Conclusion

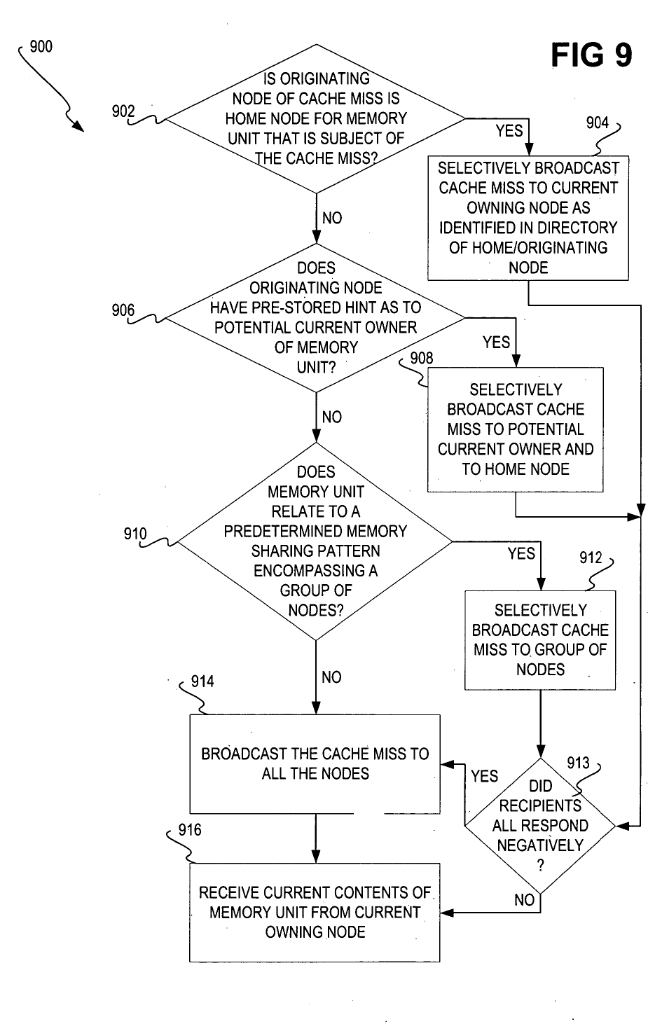

FIG. 9 shows a method 900 for determining whether to selectively broadcast the cache miss to a group of nodes lesser in number than all the nodes of the system or broadcast the cache miss to all the nodes of the system, according to an embodiment of the invention. The method 900 is consistent with the method 200 of FIG. 2 that has been described, and furthermore encompasses the methods 400, 600, and 800 of FIGS. 4, 6, and 8, respectively, that have been described. The method 900 is performed by the originating node of a cache miss relating to a given memory unit. The method 900 is provided as a summary of an embodiment of the invention that may encompass one or more of the other embodiments of the invention that have been described.

If the originating node of the cache miss is also the home node for the memory unit that is the subject of the cache miss (902), then the cache miss is selectively broadcast to the current owning node of the memory unit (904), as identified in the directory maintained by the home/originating node. If not, but if the originating node has a pre-stored hint as to the potential current owner of the memory unit (906), then the cache miss is selectively broadcast both to this potential current owner and to the home node of the memory unit (908). If not, but if the memory unit relates to a predetermined memory sharing pattern encompassing a group of nodes (910), then the cache miss is selectively broadcast to this group of nodes (912). Otherwise, the cache miss is broadcast to all the nodes (914). In the case where the cache miss is selectively broadcast in 904, 908, or 912, if all the recipient nodes of the selective broadcast respond negatively, indicating that none of them currently own the memory unit (913), then the cache miss is still broadcast to all the nodes (914). Ultimately, the originating node receives the current contents of the memory unit from the current owning node (916).

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

1. A cache-coherent system comprising:
a memory having a plurality of memory units;
a plurality of nodes employing a coherence protocol to maintain cache coherence of the memory;
a cache within each node to temporarily store contents of the plurality of memory units; and,
logic within each node to determine whether a cache miss relating to a memory unit should be transmitted to one or more nodes lesser in number than the plurality of nodes, based on a criteria.

2. The system of claim 1, wherein the criteria includes whether, to ultimately reach an owning node for the memory unit, such transmission is likely to reduce total communication traffic among the plurality of nodes and unlikely to increase latency as compared to broadcasting the cache miss to all of the plurality of nodes.

3. The system of claim 1, wherein the logic within each node is to determine whether the node is a home node for the memory unit to which the cache miss relates in determining that transmission to the one or more nodes lesser in number than the plurality of nodes is likely to reduce total communication traffic among the plurality of nodes and unlikely to increase latency to ultimately reach the owning node for the memory unit.

4. The system of claim 3, wherein the one or more nodes comprises an owning node for the memory unit as stored at a directory of the home node.

5. The system of claim 1, wherein the logic within each node is to determine whether the cache of the node has stored a hint as to a potential owning node for the memory unit as a result of an earlier event in determining that transmission to the one or more nodes lesser in number than the plurality of nodes is likely to reduce total communication traffic among the plurality of nodes and unlikely to increase latency to ultimately reach the owning node for the memory unit.

6. The system of claim 5, wherein the event includes an invalidation of the memory unit by the potential owning node.

7. The system of claim 5, wherein the one or more nodes comprises a home node of the memory unit and the potential owning node for the memory unit.

8. The system of claim 1, wherein the logic within each node is to determine whether the memory unit relates to a predetermined memory sharing pattern encompassing the one or more nodes in determining that transmission to the one or more nodes lesser in number than the plurality of nodes is likely to reduce total communication traffic among the plurality of nodes and unlikely to increase latency to ultimately reach the owning node for the memory unit.

9. A method comprising:
determining at a first node whether a cache miss relating to a memory unit of a shared memory system of a plurality of nodes including the first node and employing a coherence protocol should be selectively broadcast to one or more nodes lesser in number than the plurality of nodes based on a criteria;
in response to determining that the cache miss should be selectively broadcast to the one or more nodes, selectively broadcasting the cache miss by the first node to the one or more nodes.

10. The method of claim 9, further comprising, in response to determining that the cache miss should not be selectively broadcast to the one or more nodes, broadcasting the cache miss by the first node to all of the plurality of nodes.

11. The method of claim 9, wherein the criteria includes whether selective broadcasting is likely to reduce total communication traffic among the plurality of nodes and unlikely to increase latency as compared to just broadcasting the cache miss to all of the plurality of nodes to reach an owning node for the memory unit.

12. The method of claim 9, wherein determining whether the cache miss should be selectively broadcast to the one or more nodes comprises determining whether the first node is a home node for the memory unit, such that selectively broadcasting the cache miss to the one or more nodes comprises selectively broadcasting the cache miss to one node of the plurality of nodes as an owning node for the memory unit as stored at a directory of the first node as the home node for the memory unit.

13. The method of claim 9, wherein determining whether the cache miss should be selectively broadcast to the one or more nodes comprises determining whether the first node has a pre-stored hint as to a potential owning node for the memory unit, such that selectively broadcasting the cache miss to the one or more nodes comprises selectively broadcasting the cache miss both to a home node of the memory unit and to the potential owning node for the memory unit.

14. The method of claim 9, wherein determining whether the cache miss should be selectively broadcast to the one or more nodes comprises determining whether the memory unit relates to a predetermined memory sharing pattern encompassing the one or more nodes, such that selectively broadcasting the cache miss to the one or more nodes comprises selectively broadcasting the cache miss to the one or more nodes.

15. A method comprising:
determining at a first node whether a cache miss relating to a memory unit of a shared memory system of a plurality of nodes including the first node and employing a coherence protocol should be selectively broadcast to one or more nodes lesser in number than the plurality of nodes, based on whether selective broadcasting is likely to reduce total communication traffic among the plurality of nodes and unlikely to increase latency as compared to just broadcasting the cache miss to all of the plurality of nodes to reach an owning node for the memory unit; and,
in response to determining that the cache miss should be selectively broadcast to the one or more nodes, selectively broadcasting the cache miss by the first node to the one or more nodes.

16. A method comprising:
determining at a first node whether a cache miss relating to a memory unit of a shared memory system of a plurality of nodes including the first node should be selectively broadcast to one or more other nodes of the plurality of nodes, based on whether the first node is a home node for the memory unit or whether the first node has a pre-stored hint as to a potential owning node for the memory unit;
in response to determining that the cache miss should be selectively broadcast to the one or more other nodes, selectively broadcasting the cache miss by the first node to the one or more other nodes;
otherwise, determining at the first node whether the memory unit relates to a predetermined memory sharing pattern encompassing a sub-plurality of the plurality of nodes smaller in number than the plurality of nodes; and,
in response to determining that the memory unit relates to the predetermined memory sharing pattern, selectively broadcasting the cache miss by the first node to the sub-plurality of the plurality of nodes.

17. A node of a system having a plurality of nodes comprising:
local memory for which the node is a home node and that is shared among the plurality of nodes;
a directory to track which of the plurality of nodes has cached or modified the local memory of the node;
a cache to temporarily store contents of the local memory and memories of other ones of the plurality of nodes; and,
logic to determine whether a cache miss relating to a local memory should be transmitted to one or more nodes lesser in number than the plurality of nodes based on whether, to ultimately reach an owning node for the local memory, such transmission is likely to reduce total communication traffic among the plurality of nodes and unlikely to increase latency as compared to broadcasting the cache miss to all of the plurality of nodes.

18. An article of manufacture comprising:
a computer-readable medium; and,
means in the medium for selectively broadcasting a cache miss relating to a memory unit of a shared memory system of a plurality of nodes employing a coherence protocol to one or more nodes lesser in number than all the plurality of nodes of the shared memory system, based on a criteria.

19. The article of claim 18, wherein the means is for selectively broadcasting the cache miss to an owning node for the memory unit where an originating node of the cache miss is a home node for the memory unit.

20. The article of claim 18, wherein the means is for selectively broadcasting the cache miss to a home node for the memory unit and a potential owning node for the memory unit where an originating node of the cache miss has at a cache thereof a pre-stored hint as to the potential owning node as a sending node of an earlier received invalidation of the memory unit.

21. The article of claim 18, wherein the means is for selectively broadcasting the cache miss to a sub-plurality of the plurality of nodes smaller in number than the plurality of nodes where the memory unit relates to a predetermined memory sharing pattern encompassing the sub-plurality of the plurality of nodes.
